(19) United States
(12) Patent Application Publication
(10) Pub. No.: US 2009/0315285 A1
(43) Pub. Date: Dec. 24, 2009

(54) Low Profile Tool Carrier Apparatus

(76) Inventor: Danny Lee Glass, Chickasha, OK (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(21) Appl. No.: 12/490,756

(22) Filed: Jun. 24, 2009

Related U.S. Application Data
(60) Provisional application No. 61/075,076, filed on Jun. 24, 2008.

(51) Int. Cl. B62B 3/00; B25H 3/06

(52) U.S. Cl. 280/47.17; 280/47.34; 206/349

(57) ABSTRACT

A low-profile tool carrier. The tool carrier has a body with a rectangular, horizontal plate and vertical sides extending upwards from each side of the horizontal plate. A pair of horizontal flanges extend from the top edge of opposite vertical sides. Each of the horizontal flanges is attached to at least one ground engaging member, such as a wheel. The height from the ground to the flange is just greater than the length of the vertical sides, enabling a low profile for enhanced ease of use.

### CROSS REFERENCE TO RELATED APPLICATION

This application claims the benefit of U.S. Provisional Application No. 61/075,076 filed Jun. 24, 2008, the contents of which are incorporated fully herein by reference.

### FIELD OF THE INVENTION

The present invention relates to the field of wheeled carriers for tools.

### SUMMARY OF THE INVENTION

The present invention is directed to a tool carrier. The tool carrier comprises a horizontal plate, a vertical surface, a flange, and a plurality of ground engaging members. The vertical surface is connected to the horizontal plate at a perimeter of the horizontal plate. The flange substantially parallel to the horizontal plate and is connected to the vertical surface. The distance between the horizontal plate and the flange along the vertical surface defines a first length. The plurality of ground engaging members is attached to the flange. Each of the ground engaging members has a height just greater than the first length.

Another embodiment of the present invention is directed to a tool carrier. The tool carrier comprises a body, a first and a second flange, and two wheels. The body comprises a horizontal plate and a vertical surface attached to the horizontal plate along a perimeter of the horizontal plate. The vertical surface extends up from the horizontal plate. The first flange is connected to a top of the vertical surface at a first end of the tool carrier. The second flange is connected to a top of the vertical surface at a second end of the tool carrier. The distance between the horizontal plate and each of the two flanges along the vertical surface defines a first length. Each of the wheels has a height not substantially greater than the first length.

### BRIEF DESCRIPTION OF THE DRAWINGS

FIG. 1 is a top right perspective view of the wheeled carrier of the present invention.

FIG. 2 is a side view of the invention shown in FIG. 1.

FIG. 3 is a top view of the invention shown in FIG. 1.

FIG. 4 is a front view of the invention shown in FIG. 1.

FIG. 5 is a bottom view of the invention shown in FIG. 1.

FIG. 6 is a back view of the invention shown in FIG. 1.

### DETAILED DESCRIPTION OF THE DRAWINGS

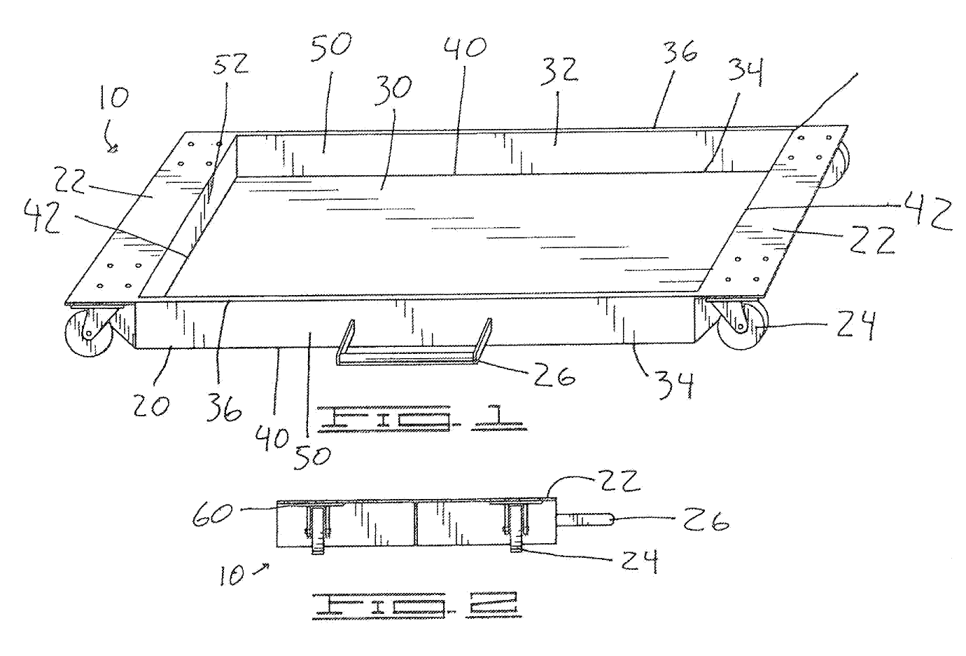

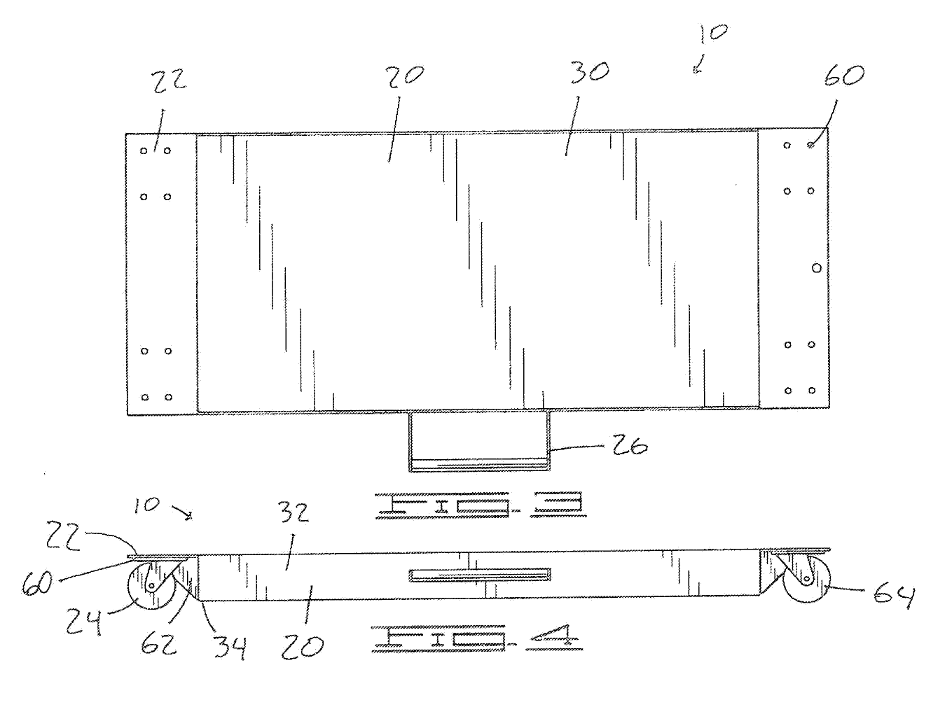

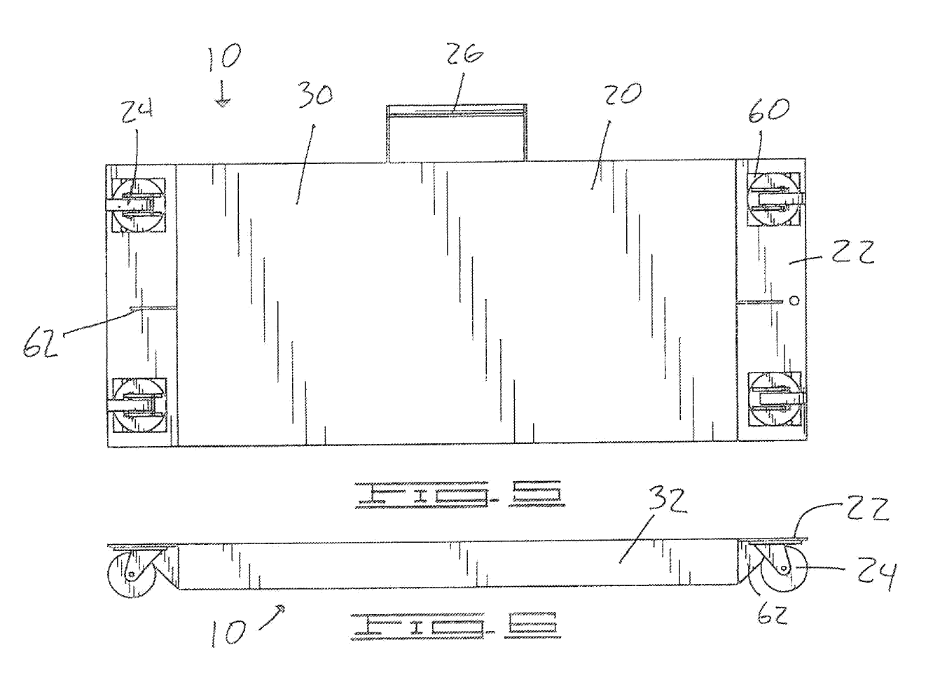

Turning to the drawings in general and FIG. 1 in particular, shown therein is a tool carrier for mobility of tools. The tool carrier, which is given reference number 10, comprises a body 20, at least one flange 22, and a plurality of ground engaging members 24. As shown, the tool carrier 10 further comprises a handle 26.

The body 20 comprises a horizontal plate 30 and a vertical surface 32. The vertical surface 32 comprises a bottom edge 34 and a top edge 36. The vertical surface 32 is defined by a length between the bottom edge 34 and the top edge 36. The vertical surface 32 is attached to a perimeter of the horizontal plate 30 at the bottom edge 34 of the vertical surface. The horizontal plate 30 is generally perpendicular to the vertical surface 32. The horizontal plate 30 is preferably generally rectangular in shape. Alternatively, the horizontal plate 30 may have rounded corners, may be square, or have another shape. In the rectangular embodiment of the horizontal plate 30 shown in FIG. 1, the horizontal plate 30 comprises two long sides 40 and two short sides 42. Thus, the portions of the vertical surface 32 extending upwards from the two long sides 40 are long portions 50, and the portions of the vertical surface extending from the two short sides 42 are short portions 52. The handle 26 is preferably attachable to the body 20 at a long portion 50 of the vertical surface 30.

The body 20 and handle 26 are composed of a metal, plastic, ceramic, or similar durable material. In a preferred embodiment, the horizontal plate 30 may comprise ridges, depressions, and/or friction-increasing material.

The at least one flange 22 is attached to the vertical surface 32 at the top edge 36 of the vertical surface. Preferably, the at least one flange 22 is a horizontal surface. As shown, the flange 22 is parallel to the horizontal plate 30. Preferably, the at least one flange 22 extends outward from a short portion 52 of the vertical surface 32. In the embodiment shown in FIG. 1, the at least one flange 22 does not extend inward from the vertical surface 32. Alternatively, the at least one flange 22 may extend inward from a short portion 52 of the vertical surface 32 to provide a partial enclosure (not shown) above the horizontal plate 30. In the preferred embodiment shown in FIG. 1, tool carrier 10 comprises two flanges 22, or a first and a second flange, that extend outward from opposite short portions 52 of the vertical surface 32. Alternatively, the two flanges 22 may extend outward from opposite long portions 50 of the vertical surface 32, or a flange may extend from the entire top edge 36 of the vertical surface.

With reference now to FIG. 2, each of the flanges 22 comprises a connection point 60. One of the plurality of ground engaging members 24 is adapted to attach to the flange 22 at the connection point 60. Preferably, as shown in FIG. 2, each flange 22 comprises two connection points 60 for connection to one of the plurality of ground engaging members 24. For additional stability as shown in FIG. 4, the tool carrier 10 further comprises a gusset 62 extending from proximate the bottom edge 34 of the vertical surface 32 to the at least one flange 22.

With continued reference to FIG. 4, each of the ground engaging members 24 comprises a wheel assembly 64. Preferably, the wheel assembly 64 comprises a rotating caster. The ground engaging members 24 provide mobility to the tool carrier 10. Each ground engaging member 24 is defined by a height from the ground to the connection point 60 of the at least one flange 22. As shown in FIG. 4, the height is greater than the length of the vertical surface 32. Preferably, the height is between 105% and 140% of the length of the vertical surface 32, such that the tool carrier 10 is both mobile and low to the ground.

The tool carrier 10 of the present invention may be used in conjunction with other similar tool carriers in various sizes, as the compact design enables the tool carriers to be stacked for easy storage. Alternative tool carriers 10 may be defined by a shorter long side 40 of the horizontal plate 30. Further, the ground engaging members 24 of alternative tool carriers 10 may be attached to the horizontal plate 30 rather than the flange 22, as shown in U.S. Design Patent Application No. 29/338,863, filed Jun. 19, 2009, the contents of which are incorporated by reference.

Various modifications in the design and operation of the present invention are contemplated without departing from the spirit of the invention. Thus, while the principal preferred construction and modes of operation of the invention have been illustrated and described in what is now considered to represent its best embodiments it should be understood that the invention may be practiced otherwise than as specifically illustrated and described.

What is claimed is:

1. A tool carrier comprising:
a horizontal plate;
a vertical surface, wherein the vertical surface is connected to the horizontal plate at a perimeter of the horizontal plate;
a flange, wherein the flange is substantially parallel to the horizontal plate and is connected to the vertical surface;
wherein the distance between the horizontal plate and the flange along the vertical surface defines a first length;
a plurality of ground engaging members attached to the flange, each of the ground engaging members having a height greater than the first length.

2. The tool carrier of claim 1 wherein at least one of the plurality of ground engaging members comprises a wheel.

3. The tool carrier of claim 1 wherein at least one of the plurality of ground engaging members comprises a caster.

4. The fool carrier of claim 1 wherein the height of each of the ground engaging members is between 105% and 140% of the first length.

5. The tool carrier of claim 1 wherein the horizontal plate is rectangular such that the horizontal plate comprises two long sides and two short sides, wherein two long portions of the vertical surface are connected to the horizontal plate at the two long sides and two short portions of the vertical surface are connected to the horizontal plate at the two short sides.

6. The tool carrier of claim 5 further comprising a handle attached to one of the two long portions of the vertical surface.

7. The tool carrier of claim 5 wherein the flange is connected to one of the two short portions of the vertical surface.

8. The tool carrier of claim 7 wherein a second flange is connected to one of the two short portions of the vertical surface.

9. The tool carrier of claim 5 wherein the flange is connected to both of the two short portions of the vertical surface.

10. The tool carrier of claim 1 wherein each of the ground engaging members comprises a wheel.

11. A tool carrier comprising:
a body comprising a horizontal plate and a vertical surface attached to the horizontal plate along a perimeter of the horizontal plate, the vertical surface extending up from the plate;
a first and a second flange, wherein the first flange is connected to a top of the vertical surface at a first end of the tool carrier and the second flange is connected to a top of the vertical surface at a second end of the tool carrier;
wherein the distance between the horizontal plate and each of the two flanges along the vertical surface defines a first length;
two wheels attached to the first flange, each of the wheels having a height not substantially greater than the first length; and
two wheels attached to the second flange, each of the wheels having a height not substantially greater than the first length.

12. The tool carrier of claim 11 wherein the height of each of the wheels is between 105% and 140% of the first length.
